(19) United States
(12) Patent Application Publication
(10) Pub. No.: US 2025/0167343 A1
(43) Pub. Date: May 22, 2025

(54) BATTERY AND ELECTRONIC DEVICE

(71) Applicant: HON HAI PRECISION INDUSTRY CO., LTD., New Taipei (TW)

(72) Inventors: JONG-RU RAU, New Taipei (TW); Yin-Hao Lo, New Taipei (TW); Chung-Chun Lin, New Taipei (TW); Yu-Hao Fang, New Taipei (TW); Yu-Fan Su, New Taipei (TW); Yang-Chuan Tsai, New Taipei (TW); Yu-Ti Sha, New Taipei (TW); Guan-Zhen Gu, New Taipei (TW)

(21) Appl. No.: 18/948,757

(22) Filed: Nov. 15, 2024

(30) Foreign Application Priority Data
Nov. 16, 2023 (CN) 202323123726.8

(51) Int. Cl. H01M 10/6557; H01M 50/105; H01M 50/202; H01M 50/224; H01M 50/531; H01M 50/548

(52) U.S. Cl. CPC H01M 10/6557; H01M 50/105; H01M 50/202; H01M 50/224; H01M 50/531; H01M 50/548

(57) ABSTRACT

The present application relates to a battery and an electronic device. The battery includes a first shell, a second shell, and a battery core. The first shell provides a receiving cavity. The battery core is disposed in the receiving cavity. The second shell is disposed on a side of the battery core away from the first shell, and the second shell is connected to the first shell. A support structure is provided at an outer surface of the second shell away from the battery core. The support structure is provided protruding from the outer surface of the second shell, and heat dissipation channels are formed between the support structure and the outer surface of the second shell.

### CROSS-REFERENCE TO RELATED APPLICATIONS

This application claims all benefits under 35 U.S.C § 119 from the Chinese Patent Application NO. 202323123726.8, filed on Nov. 16, 2023, in the China National Intellectual Property Administration, the disclosure of which is incorporated herein by reference.

### FIELD

The present disclosure relates to a technical field of battery structure, particularly to a battery and an electronic device having the battery.

### BACKGROUND

Existing soft pack lithium batteries are widely used in 3C electrical products and electric bicycles, electric locomotives, electric vehicles and even large-scale energy storage systems and other battery structures. However, the mechanical strength of soft pack lithium batteries is low, easy to be damaged by external forces, and there are also heat dissipation defects when the batteries are stacked, which is prone to the problem of overheating of the batteries.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a schematic drawing of a battery according to an embodiment of the present disclosure.

FIG. 2 is a schematic drawing of the battery of FIG. 1 in another direction.

FIG. 3 is an explosion view of the battery in FIG. 1.

FIG. 4 is a cross-sectional view of the battery of FIG. 1 in direction of IV-IV.

FIG. 5 is a schematic drawing of two batteries which are stacked.

FIG. 6 is schematic drawing of two batteries connected front to back.

FIG. 7 is a schematic drawing of a partial structure of the battery.

FIG. 8 is a schematic drawing of an electronic device in an embodiment.

### DETAILED DESCRIPTION

In order to make the above-mentioned objects, features, and advantages of the present disclosure more obvious, specific embodiments of the present disclosure will be described with reference to the accompanying drawings. The present disclosure can be implemented in ways different from those described herein, and those skilled in the art can make similar improvements without violating the contents of the present disclosure. Therefore, the present disclosure is not to be considered as limiting the scope of the embodiments to those described herein.

Several definitions that apply throughout this disclosure will now be presented.

Unless otherwise defined, all technical and scientific terms used herein have the same meaning as commonly understood by one skilled in the art. The terms used in the present disclosure herein are only for describing specific embodiments, and are not intended to limit the present disclosure.

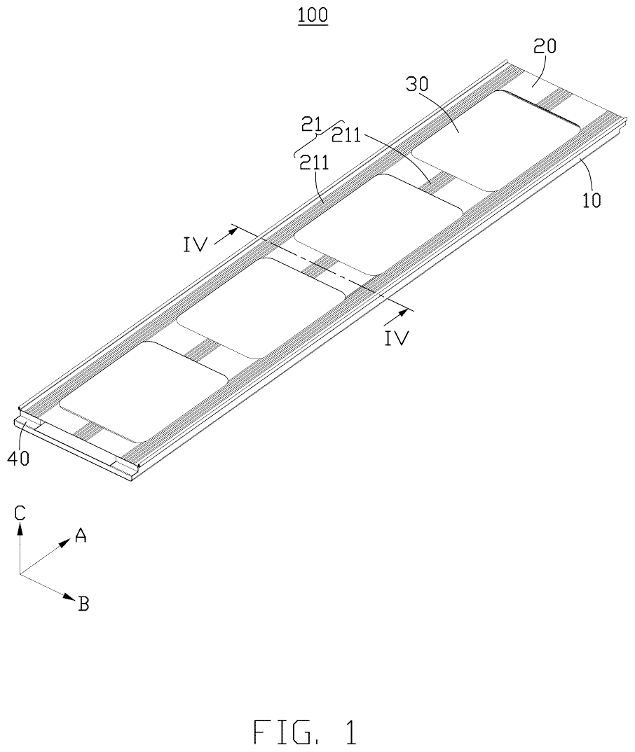

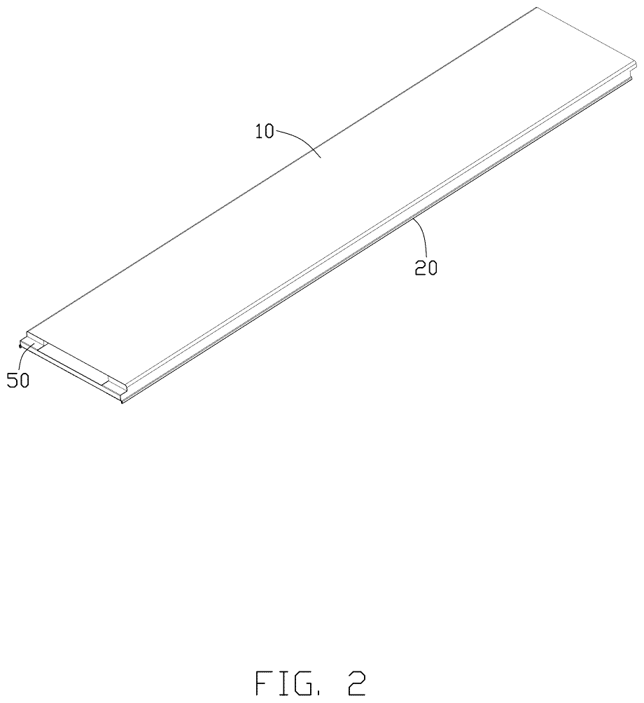

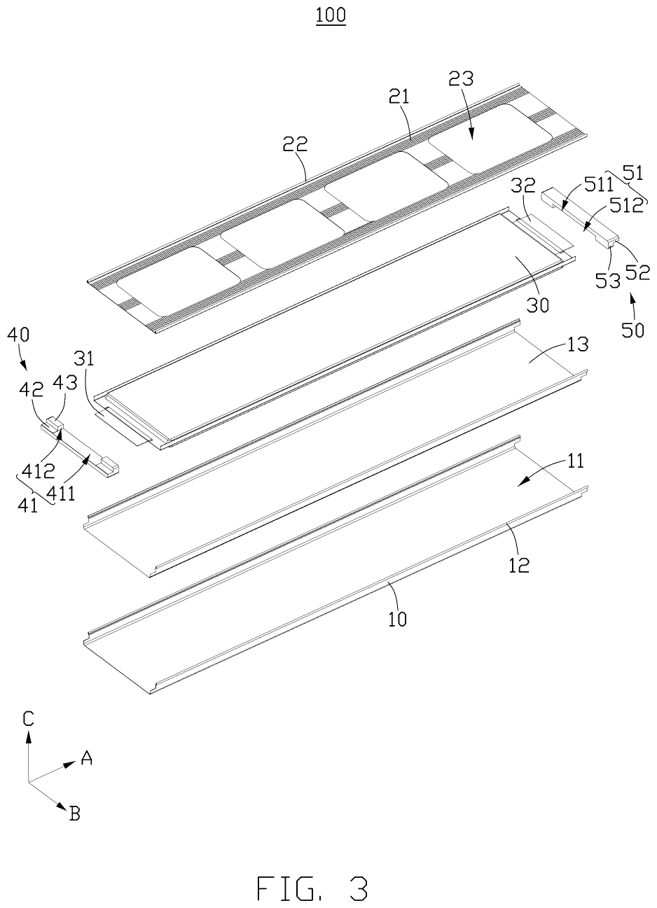

Referring to FIG. 1, FIG. 2, and FIG. 3, an embodiment of the present application provides a battery 100, the battery 100 includes a first shell 10, a second shell 20, and a battery core 30. A receiving cavity 11 is provided in the first shell 10. The battery core 30 is disposed in the receiving cavity 11. The second shell 20 is disposed on a side of the battery core 30 away from the first shell 10, and the second shell 20 is connected to the first shell 10, to make the battery core 30 is housed in the first shell 10 and the second shell 20, and the first shell 10 and the second shell 20 withstand external shocks, improving the overall mechanical properties of the battery 100. A support structure 21 is provided at an outer surface of the second shell 20 away from the battery core 30. The support structure 21 is provided protruding from the outer surface of the second shell 20, and heat dissipation channels are formed between the support structure 21 and the outer surface of the second shell 20. In this way, when two batteries 100 are stacked, the first shell 10 and the second shell 20 can support weight of the battery 100 above them, and the support structure 21 on the second shell 20 can form a gap between the two batteries 100, avoiding the two batteries 100 from being completely attached to each other, and heat dissipation medium can flow through the heat dissipation channels between the two batteries 100, thereby reducing risk of overheating.

In one embodiment, the battery core 30 includes a first electrode plate, a second electrode plate, a diaphragm, and a packaging shell. An electrode polarity of the first electrode plate is opposite to an electrode polarity of the second electrode plate, and the diaphragm being provided between the first electrode plate and the second electrode plate. The first electrode plate, the second electrode plate, and the diaphragm may be, but not limited to be, stacked or coiled. The first electrode plate, the second electrode plate and the diaphragm are stacked or coiled and encapsulated in the packaging shell, and the packaging shell is filled with electrolyte. The packaging shell may be a flexible packaging shell, so that the battery core 30 is a soft pack battery 100. In other embodiments, the packaging shell may be a rigid packaging shell, which is conducive to improve the mechanical properties of the battery 100.

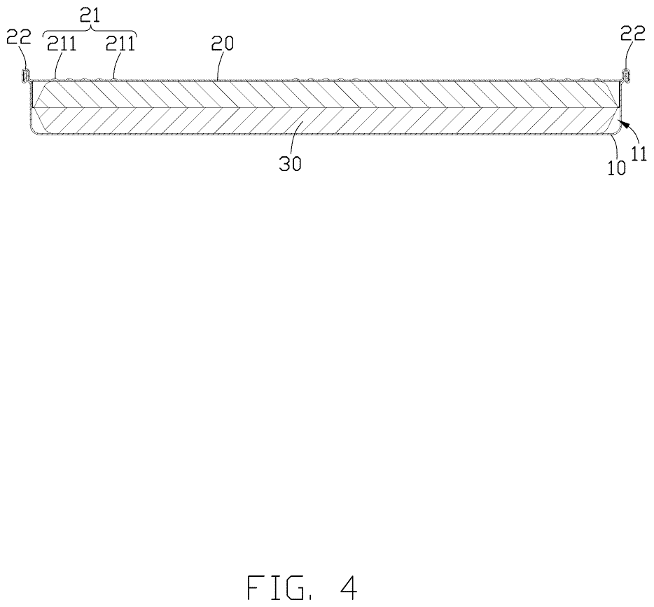

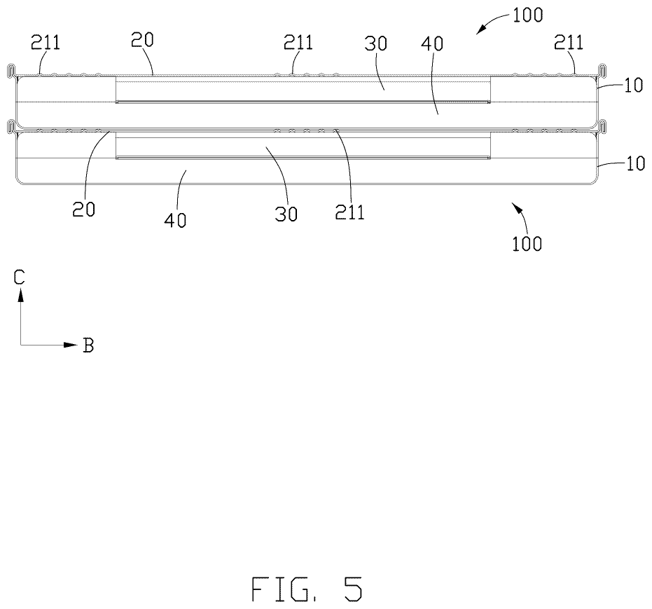

Referring to FIG. 1, FIG. 4, and FIG. 5, the support structure 21 includes a plurality of protruding portions 211, the plurality of protruding portions 211 extending along a length direction A of the battery 100. In a width direction B of the battery 100, the plurality of protruding portions 211 being disposed side by side and spaced apart from each other. The heat dissipation channels are formed between adjacent protruding portions 211 and also between the protruding portion 211 and the outer surface of the second shell 20. When two batteries 100 are stacked, the plurality of protruding portions 211 abuts against the battery 100 located on top of them, providing a support function and increasing the structural strength of the second shell 20. In addition, the plurality of protruding portions 211 and the second shell 20 are integrally molded structures, and outer surfaces of the plurality of protruding portions 211 are heat dissipation surfaces of the second shell 20, which can increase a total area of heat dissipation of the second shell 20, and improve the heat dissipation efficiency.

In one embodiment, the plurality of protruding portions 211 are substantially in a wave-shaped structure and may be formed on the second shell 20 by stamping. The plurality of protruding portions 211 may be divided into a plurality of groups, and the plurality of groups of protruding portions 211 are uniformly distributed on the outer surface of the second shell 20, so as to enable balanced stress when the batteries 100 are stacked, improving the compression strength of the batteries 100, and enhancing the stability of the batteries 100 stacked. In the embodiment shown in FIG. 1, the protruding portions 211 are divided into three groups, two groups of protruding portions 211 are disposed closes to opposite sides of the second shell 20, and one group of protruding portions 211 is disposed generally in a central area of the second shell 20.

In one embodiment, the second shell 20 is a metal shell, and the battery core 30 contacts the metal shell so that the heat generated by the battery core 30 can be conducted to the metal shell. The metal shell is provided with a plurality of through grooves 23, the through grooves 23 can reduce weight of the second shell 20 and is capable of increasing the heat dissipation performance of the second shell 20. Furthermore, part of outer surface of the battery core 30 exposes at the through grooves 23, enabling heat generated by the battery core 30 to be transferred from the through grooves 23 into the heat dissipation channels.

In one embodiment, the first shell 10 may be a metal shell, which can conduct the heat generated by the battery core 30 while improving better mechanical strength. Furthermore, as shown in FIG. 3, an insulating member 13 is provided on an inner side of the first shell 10 for isolating the first shell 10 from the battery core 30, or isolating the first shell 10 from the second shell 20, to prevent the battery 100 from short-circuit conditions. The insulating member 13 may be an insulating adhesive, an insulating sheet, an insulating coating, and the like. Furthermore, the insulating member 13 has shock absorbing, cushioning, and heat conducting properties, which can absorb energy when the battery 100 falls or receives an external impact, reduce damage to the battery core 30, and can conduct the heat generated by the battery core 30 to the first shell 10 to help dissipate the heat. In another embodiment, the first shell 10 may be an insulating heat-conducting shell, so that the first shell 10 can be directly connected to the second shell 20 while conducting heat and dissipating heat, without the need to additionally set up an insulating member 13 on the inner side of the first shell 10.

Referring to FIG. 1, FIG. 2, and FIG. 3, in one embodiment, the battery 100 further includes a first connection terminal 40 and a second connection terminal 50. The first connection terminal 40 is provided at one end of the battery core 30, and the first connection terminal 40 having a first opening 41, the first opening 41 facing the second shell 20. The second connection terminal 50 is provided at another end of the battery core 30, and the second connection terminal 50 having a second opening 51, the second opening 51 facing the first shell 10. The battery core 30 further includes a first electrode tab 31 and a second electrode tab 32. The first electrode tab 31 connects the first electrode plate, and part of the first electrode tab 31 extends out of one end of the packaging shell of the battery core 30. The second electrode tab 32 is connected to the second electrode plate, and part of the second electrode tab 32 extends out of another end of the packaging shell of the battery core 30. The first electrode tab 31 is electrically connected to the first connection terminal 40, and the first electrode tab 31 is partially disposed in the first opening 41. The second electrode tab 32 is electrically connected to the second connection terminal 50, and the second electrode tab 32 is partially disposed in the second opening 51. An electrode polarity of the first connection terminal 40 is opposite to an electrode polarity of the second connection terminal 50, and the first opening 41 and the second opening 51 are oriented in different directions, which can prevent reversal of positive and negative terminals during installation of the battery 100, and acts as an anti-dulling structure.

Referring to FIG. 3, in one embodiment, the first connection terminal 40 includes a first portion 42 and a second portion 43, the second portion 43 is provided on a side of the first portion 42 facing the second shell 20, a side of the first portion 42 away from the second portion 43 abuts against the first shell 10. In the length direction A of the battery 100, a length of the second portion 43 is less than a length of the first portion 42, so that the first connection terminal 40 substantially forms an L-shaped structure. In the thickness direction C of the battery 100, middle portions of the second portion 43 and the first portion 42 are recessed to form the first opening 41, a depth of the first opening 41 is greater than a thickness of the second portion 43 and less than a sum of the thicknesses of the first portion 42 and the second portion 43. In view of FIG. 3, when the first electrode tab 31 is provided in the first opening 41, a lower surface of the first electrode tab 31 is fixed to a bottom surface of the first opening 41, and an upper surface of the first electrode tab 31 protrudes slightly from an upper surface of the first portion 42, to improve reliability of the battery 100 electrically connecting to the external structure.

In one embodiment, the first opening 41 includes a first groove 411 and a second groove 412, the first groove 411 is communicated with the second groove 412.

In the thickness direction C of the battery 100, the first groove 411 disposed on the side of the first portion 42 toward the second portion 43, and the second groove 412 extends throughout the second portion 43. A depth of the first groove 411 is less than the thickness of the first electrode tab 31, so that when the first electrode tab 31 is received in first groove 411, the upper surface of the first electrode tab 31 may protrude from the upper surface of the first portion 42.

Furthermore, the second connection terminal 50 includes a third portion 52 and a fourth portion 53, the fourth portion 53 is provided on a side of the third portion 52 towards the first shell 10, a side of the third portion 52 away from the fourth portion 53 abuts against the second shell 20. In the length direction A of the battery 100, a length of the fourth portion 53 is less than a length of the third portion 52, so that the second connection terminal 50 substantially forms an L-shaped structure. In the thickness direction C of the battery 100, middle portions the fourth portion 53 and the third portion 52 are recessed to form the second opening 51. A depth of the second opening 51 is greater than a thickness of the fourth portion 53 and less than a sum of the thicknesses of the third portion 52 and the fourth portion 53. In view of FIG. 3, when the second electrode tab 32 is received in the second opening 51, an upper surface of the second electrode tab 32 is fixed to a top surface of the second opening 51, and a lower surface of the second electrode tab 32 protrudes from a lower surface of the third portion 52.

In one embodiment, the second opening 51 includes a third groove 511 and a fourth groove 512, the third groove 511 is communicated with the fourth groove. In the thickness direction C of the battery 100, the third groove 511 is provided on a side of the third portion 52 towards the fourth portion 53, and the fourth groove 512 extends throughout the fourth portion 53. A depth of the third groove 511 is less than a thickness of the second electrode tab 32, so that when the second electrode tab 32 is received in the third groove 511, the lower surface of the second electrode tab 32 may protrude from the lower surface of the third portion 52.

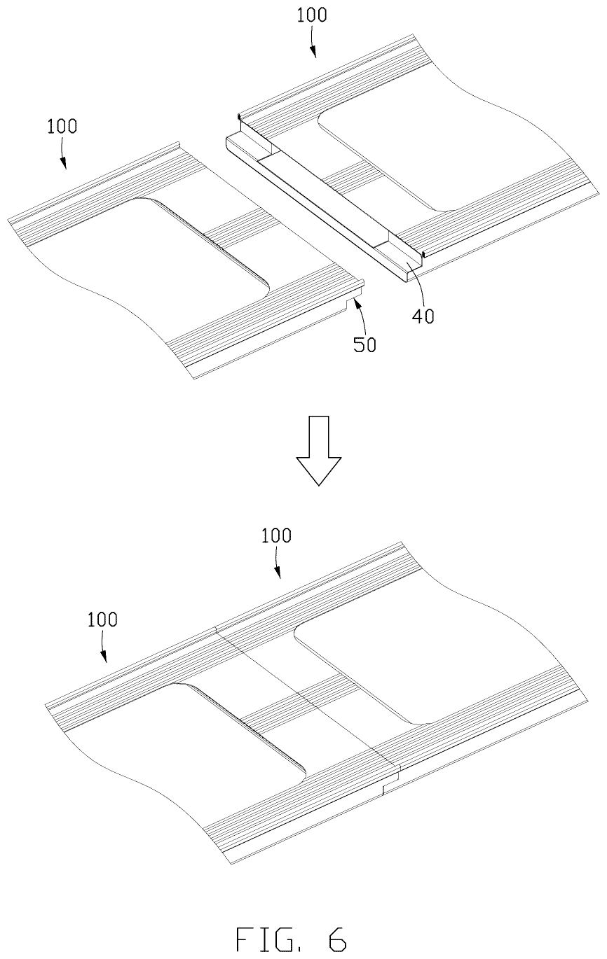

Referring to FIG. 6, in one embodiment, when two or more batteries 100 are connected in sequence in the length direction A of the battery 100, the second connection terminal 50 of a former battery 100 can be coupled with the first connection terminal 40 of a latter battery 100, and the second electrode tab 32 of the former battery 100 is in contact with the first electrode tab 31 of the latter battery 100, achieving series connection of the two batteries 100 in a simple and reliable way, and positioning the two or more batteries 100.

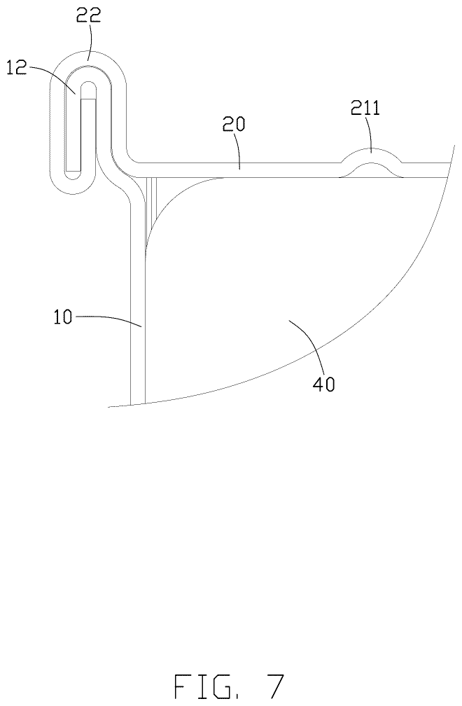

Referring to FIG. 5 and FIG. 7, in one embodiment, in the width direction B of the battery 100, opposite sides of the second shell 20 are provided with limiting portions 22, and in the thickness direction C of the battery 100, a height of the limiting portions 22 is greater than a height of the support structure 21. In this way, when two or more batteries 100 are stacked up and down, the limiting portions 22 can act as locators for the sides of the batteries 100, reducing the problem of crookedness or collapse when the batteries 100 are stacked.

In one embodiment, opposite sides of the first shell 10 are provided with positioning portions 12 corresponding to the limiting portions 22, and the positioning portions 12 are nested with the limiting portions 22 to fix the relative positions of the first shell 10 and the second shell 20 to enhance the structural stability of the batteries 100. In one embodiment, the limiting portion 22 and the positioning portion 12 are nested by means of stacking and coiling. Stacked winding of the limiting portion 22 and the positioning portion 12 may be achieved by a sheet metal process. In other embodiments, the limiting portion 22 and the positioning portion 12 may be nested by means of a snap connection, which is sufficient to meet the installation requirements, and the present application is not limited thereto.

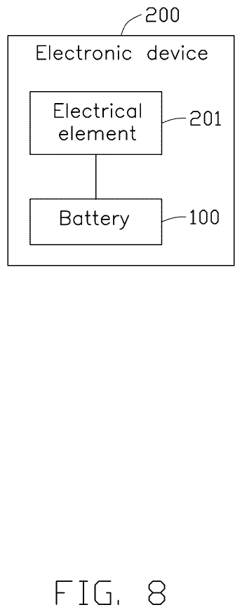

Referring to FIG. 8, embodiments of the present application further provide an electronic device 200 includes an electrical element 201 and the battery 100 as described in the above embodiments, the battery 100 is electrically connected to the electrical element 201. The electronic device 200 includes, but is not limited to, a 3C electrical product, an electric bicycle, an electric motorized vehicle, an electric vehicle, an energy storage system, and the like.

Even though information and advantages of the present embodiments have been set forth in the foregoing description, together with details of the structures and functions of the present embodiments, the disclosure is illustrative only. Changes may be made in detail, especially in matters of shape, size, and arrangement of portions within the principles of the present embodiments to the full extent indicated by the plain meaning of the terms in which the appended claims are expressed.

What is claimed is:

1. A battery, comprising:
a first shell providing with a receiving cavity,
a battery core disposed in the receiving cavity,
a second shell disposed on a side of the battery core away from the first shell, and the second shell is connected to the first shell, a support structure is provided at an outer surface of the second shell away from the battery core, the support structure is provided protruding from the outer surface of the second shell, and heat dissipation channels are formed between the support structure and the outer surface of the second shell.

2. The battery as claimed in claim 1, wherein, the support structure comprises a plurality of protruding portions, the plurality of protruding portions extends in a length direction of the battery, in a width direction of the battery, the plurality of protruding portions is disposed side by side and spaced apart from each other.

3. The battery as claimed in claim 1, wherein, the battery further comprising:
a first connection terminal provided at one end of the battery core, the first connection terminal having a first opening, the first opening facing the second shell, and
a second connection terminal provided at another end of the battery core, the second connection terminal having a second opening, the second opening facing the first shell.

4. The battery as claimed in claim 3, wherein, the first connection terminal comprises a first portion and a second portion, the second portion is provided on a side of the first portion facing the second shell, a side of the first portion away from the second portion abuts against the first shell, in the length direction of the battery, a length of the second portion is less than a length of the first portion.

5. The battery as claimed in claim 3, wherein, the second connection terminal comprises a third portion and a fourth portion, the fourth portion is provided on a side of the third portion towards the first shell, a side of the third portion away from the fourth portion abuts against the second shell, in the length direction of the battery, a length of the fourth portion is less than a length of the third portion.

6. The battery as claimed in claim 1, wherein, in a width direction of the battery, opposite sides of the second shell are provided with limiting portions, in a thickness direction of the battery, a height of the limiting portions is greater than a height of the support structure.

7. The battery as claimed in claim 6, wherein, opposite sides of the first shell are provided with positioning portions corresponding to the limiting portions, and the positioning portions are nested with the limiting portions.

8. The battery as claimed in claim 1, wherein, the second shell is a metal shell, the metal shell is provided with a plurality of through grooves, the battery core contacts the metal shell, part of outer surface of the battery core exposes at the through grooves.

9. The battery as claimed in claim 3, wherein, the battery core comprises a first electrode tab and a second electrode tab, the first electrode tab is electrically connected to the first connection terminal, and the first electrode tab is partially disposed in the first opening, the second electrode tab is electrically connected to the second connection terminal, and the second electrode tab is partially disposed in the second opening.

10. An electronic device, comprising:
an electrical element, and
a battery electrically connected to the electrical element, the battery comprising:
a first shell providing with a receiving cavity,
a battery core disposed in the receiving cavity,
a second shell disposed on a side of the battery core away from the first shell, and the second shell is connected to the first shell, a support structure is provided at an outer surface of the second shell away from the battery core, the support structure is provided protruding from the outer surface of the second shell, and heat dissipation channels are formed between the support structure and the outer surface of the second shell.

11. The electronic device as claimed in claim 10, wherein, the support structure comprises a plurality of protruding portions, the plurality of protruding portions extends in a length direction of the battery, in a width direction of the battery, the plurality of protruding portions is disposed side by side and spaced apart from each other.

12. The electronic device as claimed in claim 10, wherein, the battery further comprising:
a first connection terminal provided at one end of the battery core, the first connection terminal having a first opening, the first opening facing the second shell, and
a second connection terminal provided at another end of the battery core, the second connection terminal having a second opening, the second opening facing the first shell.

13. The electronic device as claimed in claim 12, wherein, the first connection terminal comprises a first portion and a second portion, the second portion is provided on a side of the first portion facing the second shell, a side of the first portion away from the second portion abuts against the first shell, in the length direction of the battery, a length of the second portion is less than a length of the first portion.

14. The electronic device as claimed in claim 12, wherein, the second connection terminal comprises a third portion and a fourth portion, the fourth portion is provided on a side of the third portion towards the first shell, a side of the third portion away from the fourth portion abuts against the second shell, in the length direction of the battery, a length of the fourth portion is less than a length of the third portion.

15. The electronic device as claimed in claim 10, wherein, in a width direction of the battery, opposite sides of the second shell are provided with limiting portions, in a thickness direction of the battery, a height of the limiting portions is greater than a height of the support structure.

16. The electronic device as claimed in claim 15, wherein, opposite sides of the first shell are provided with positioning portions corresponding to the limiting portions, and the positioning portions are nested with the limiting portions.

17. The electronic device as claimed in claim 10, wherein, the second shell is a metal shell, the metal shell is provided with a plurality of through grooves, the battery core contacts the metal shell, part of outer surface of the battery core exposes at the through grooves.

18. The electronic device as claimed in claim 12, wherein, the battery core comprises a first electrode tab and a second electrode tab, the first electrode tab is electrically connected to the first connection terminal, and the first electrode tab is partially disposed in the first opening, the second electrode tab is electrically connected to the second connection terminal, and the second electrode tab is partially disposed in the second opening.
